(19) United States
(12) Patent Application Publication
(10) Pub. No.: US 2026/0087525 A1
(43) Pub. Date: Mar. 26, 2026

(54) SYSTEM AND METHOD FOR INTEGRATING LANDING PAGES INTO CAMPAIGN TOOL

(71) Applicant: GUPSHUP TECHNOLOGY INDIA PRIVATE LIMITED, Maharashtra (IN)

(72) Inventor: Nirmesh MEHTA, Maharashtra (IN)

(21) Appl. No.: 19/334,352

(22) Filed: Sep. 19, 2025

(30) Foreign Application Priority Data
Sep. 21, 2024 (IN) 202421071509

(51) Int. Cl. G06Q 30/0241; G06Q 10/0639; G06Q 30/0242

(52) U.S. Cl. CPC G06Q 30/0276; G06Q 10/06398; G06Q 30/0242; G06Q 30/0277

(57) ABSTRACT

The present invention discloses a system (100) for integrating landing pages (108) into a campaign tool (110). The system (100) comprises a user device (102) configured to exchange campaign-related messages through a channel (104). A campaign tool (110) enables a marketer (114) to register campaign metadata, upload or segment target users, and link outbound campaigns with a plurality of chat landing pages (108). The landing pages (108) are configured to track campaign messages, verify them against stored campaign details, forward verified messages via the CPaaS platform (106), and execute predefined chat journeys in response to inbound user messages. The system (100) enables dynamic chat landing pages (108) to function within messaging channels (104), preserving campaign context and automating interactive workflows until completion or handoff, thereby improving personalization, reducing manual intervention, and enhancing efficiency of multi-channel campaign execution

### CROSS REFERENCE TO RELATED APPLICATION AND PRIORITY

The present invention claims priority from Indian Patent Application number 202421071509 filed on date 21 Sep. 2024.

### FIELD OF THE INVENTION

The present invention pertains to a system and method that leverages consumer interactions for the selling and marketing of goods and services through a messaging or chat platform. Specifically, this invention offers a communication system and method that delivers content to the user or consumer's attention via online conversations or posts.

### BACKGROUND OF THE INVENTION

Currently, marketers are widely using business messaging. There are increasing use cases to promote or sell products over messaging. Often this involves sending out a large volume of outbound messages or setting up click-to-chat ads to get end users interested and having bots assist them in fulfillment. The setup of these bots is a big and time-consuming effort, especially if the bots involve AI or NLP. On the other hand, marketing teams often need to work at fast pace for specific events, since the advertising campaigns are tied to it. So, the marketing team needs a system that decouples advertising campaigns from the long build cycles and complexity of bots.

In modern digital marketing and customer engagement, enterprises rely on omnichannel communication platforms to reach and interact with target audiences. Communications Platform as a Service (CPaaS) solutions have emerged as a popular framework that allows organizations to deliver outbound campaigns through multiple channels such as SMS, email, and messaging applications. However, existing CPaaS frameworks primarily focus on message delivery and campaign management, with limited capabilities to orchestrate personalized conversational journeys.

Conventional campaign management tools may lack integration with dynamic chat-based landing pages, resulting in fragmented user experiences. Campaign messages typically redirect users to static web pages or external forms, which provide little scope for interactive engagement. Consequently, marketers are unable to track campaign performance in real time or adapt campaign flows based on user responses. In addition, inbound user messages unrelated to ongoing campaigns or received after completion of campaign flows are often left unaddressed or manually redirected, creating inefficiencies and a poor customer experience.

Furthermore, traditional systems do not offer a seamless mechanism to transition conversations between automated landing page journeys, bots, and human agents. As a result, when a campaign journey requires escalation, either contextual information is lost, or the transition to bots or agents is disjointed. This leads to duplication of effort, longer resolution times, and reduced effectiveness of marketing and customer support operations.

Hence to overcome the aforesaid drawbacks a system for integration of chat landing pages is required.

### OBJECTS OF THE INVENTION

Main objective of the present invention is to provide a system and method for integrating landing pages into a CPaaS-based campaign tool that enables automated, interactive, and personalized conversational journeys linked to outbound campaigns.

Another objective of the invention is to facilitate seamless execution of chat landing page journeys that may progress based on user inputs, track campaign message delivery, and verify campaign messages against stored campaign metadata in real time.

Yet another objective of the invention is to enable intelligent handling of inbound user messages/response that are outside the scope of a registered campaign or arise upon completion of a landing page journey, by automatically forwarding such messages to a bot or human agent with contextual continuity.

Still another objective of the invention is to improve operational efficiency for marketers by allowing campaign metadata registration, user segmentation, campaign-to-landing page linking, and workflow validation through the campaign tool.

A final objective of the invention is to enhance customer engagement and campaign performance by ensuring that outbound messages, inbound responses, bot interactions, and agent handoffs occur in a seamless, scalable, and context-preserving manner.

### SUMMARY OF THE INVENTION

Before the present campaign pacing with minimal integration is described, it is to be understood that this application is not limited to a particular system and method for integrating landing pages into a campaign tool as there may be multiple possible embodiments, which are not expressly illustrated in the present disclosures. It is also to be understood that the terminology used in the description is for the purpose of describing the particular implementations, versions, or embodiments only, and is not intended to limit the scope of the present application. This summary is provided to introduce aspects related to the campaign pacing system. This summary is not intended to identify essential features of the claimed subject matter nor is it intended for use in determining or limiting the scope of the claimed subject matter.

The present invention discloses a system for the integration of landing pages into a campaign tool. The system comprises a user device, a channel, a communications platform as a service (CPaaS) platform, a landing pages, a campaign tool, an agent dashboard, a marketer, and a bot developer. The landing pages are integrated between the CPaaS platform and the bot. In an embodiment, the chat landing pages are integrated with the campaign tool and the agent dashboard. In another embodiment, the chat landing pages integrates with outbound/Ad campaign tools on one side and with bot development tools on the other side. The landing pages tracks the campaign messages being sent and verifies that the landing pages link to the campaign details.

The proposed solution, “Chat Landing Pages,” acts as an intermediary between the CPaaS (Communication Platform as a Service) provider and the bot development tools. It integrates with both outbound/ad campaign tools and bot systems, allowing marketers to create campaigns and manage interactions more efficiently.

In an embodiment, the present invention provide a system for integrating landing pages into a campaign tool is disclosed. The system includes a memory that stores campaign information. This information consists of campaign metadata, target user lists, message templates, and predefined chat landing page journeys. A processor is connected to the memory and performs several operations.

First, the processor registers campaign metadata. It also uploads or segments a target user list provided by a marketer using the campaign tool. Then, it creates an outbound or advertisement campaign through the campaign tool. The campaign is linked to multiple chat landing pages.

Next, the processor sends outbound campaign messages. These messages are generated by the campaign tool and sent sequentially from the chat landing pages. They are delivered through a CPaaS platform using a selected communication channel to target users on their devices.

The processor tracks the sent messages. It verifies their link to the stored campaign metadata using the chat landing pages. It receives inbound user responses from the CPaaS platform. It checks if each response matches a pre-existing campaign using identifiers like advertisement IDs, referral codes, or reference codes.

If the response matches a campaign, the processor executes a predefined landing page journey. This journey adapts based on user inputs until it ends or a handoff condition occurs. If the response does not match or the journey ends, the processor forwards the response to a bot.

After each journey, the processor generates a context package. This package shows the state of the completed journey and simulates a user message for the bot to process. Finally, the system provides real-time access to responses and metadata through an agent dashboard. Supervisors can use the dashboard to monitor agent performance, create campaign reports, and maintain audit logs.

In an embodiment, the present invention provides that the campaign metadata comprises user identifiers, advertisement identifiers, referral codes, and attributes for uniquely identifying and tracking campaigns.

In yet another embodiment, the present invention provides that the outbound campaign comprises a bulk messaging campaign to the target user list, and the advertisement campaign comprises an advertisement linked to a messaging application.

In an embodiment, the present invention provides that the predefined landing page journey executed by the plurality of chat landing pages comprises a script defined as a predefined sequence of automated interactions.

In still another embodiment, the present invention provides that the script is implemented as a workflow graph stored in the memory as a JSON object. Each node of the workflow graph represents a processing step comprising sending a message or prompting a user input via the user device. Each edge represents a conditional transition based on the user inputs, such as text replies or selections. The script progresses dynamically until completion or a handoff condition occurs when the user input requires processing beyond the script's predefined interactions, such as a complex query or transaction request.

In yet another embodiment, the present invention provides that the bot generates context-aware responses using natural language understanding and supports dynamic handoff to live agents.

In yet another embodiment, the present invention provides that the central landing pages hub is programmed to track outgoing campaign messages sent through the campaign tool and associate each message with campaign metadata including user IDs, campaign IDs, and journey templates; receive incoming user responses through the communication channels and CPaaS platform along with message metadata and user identification; analyze the user responses using pattern matching and campaign correlation algorithms to determine relevance to existing campaigns; and route campaign-related responses to predefined journey responses stored in campaign templates with automated progression through conversation flows; and route non-campaign related responses and completed journey messages to the automated bot systems for natural language understanding, intent classification, and intelligent response generation.

In an embodiment, the present invention provides that the responses accessible via the agent dashboard comprise user conversation histories, user inputs, system responses from the plurality of chat landing pages and the bot, and pre-written replies stored in the memory for agent use. The metadata comprises conversation identifiers, campaign identifiers, and routing data for assigning user interactions to agents. The agent dashboard further provides access to a searchable knowledge database stored in the memory to enable agents to retrieve information for responding to user queries.

In still another embodiment, the present invention provides that the CPaaS platform is configured to manage the transmission of campaign-related messages between the user device and the chat landing pages. The CPaaS platform provides multi-channel message delivery across at least one of SMS, email, or messaging applications, enforces governance policies including opt-in verification and message rate limits, and ensures secure, reliable, and scalable handling of inbound and outbound messages for multiple campaigns.

In yet another embodiment, the present invention provides that the campaign tool is configured to enable the marketer to define, manage, and customize campaigns. This includes uploading or segmenting target user data and registering campaign metadata. The campaign metadata comprises user identifiers, campaign advertisement identifiers, referral codes, or other campaign-specific attributes. The campaign tool associates outbound or advertisement campaigns with a plurality of chat landing pages for automated interaction with the targeted users.

In an embodiment, the present invention provides that the plurality of chat landing pages are configured to automate repetitive campaign tasks over a network. The chat landing pages send outbound campaign messages sequentially to a list of target users uploaded by the marketer and track delivery status for each message.

In still another embodiment, the present invention provides that the processor is operably coupled to the plurality of chat landing pages, the bot, and the agent dashboard through API-based integrations.

In an embodiment, the present invention provides a method executed by a processor connected to memory, chat landing pages, a bot, and an agent dashboard. The method begins by using a campaign tool to register campaign metadata. This metadata includes user identifiers, advertisement identifiers, referral codes, and other tracking attributes. The marketer uploads or segments a target user list using the campaign tool.

The campaign tool creates either a bulk messaging campaign or an advertisement campaign linked to a messaging application. These campaigns are connected to multiple chat landing pages. The system sends outbound messages generated by the campaign tool through the chat landing pages. These messages are delivered via a CPaaS platform using a selected communication channel to user devices.

The system tracks each sent message and verifies its link to the stored campaign metadata. It receives inbound responses from the CPaaS platform. Each response is checked to see if it matches a pre-existing campaign using identifiers like ad IDs or referral codes. If a match is found, the system runs a predefined landing page script. This script is stored in memory and includes automated interactions. It progresses based on user inputs like text replies or selections. The journey ends when completed or when a handoff condition is triggered. If the response does not match a campaign or the journey ends, the system forwards the response to a bot. The bot uses natural language understanding to generate context-aware replies. It can also hand off the conversation to a live agent. After each journey, the system creates a context package. This package shows the final state of the journey and simulates a user message for the bot. The agent dashboard gives real-time access to responses, conversation histories, and pre-written replies. It also shows metadata like routing assignments. Supervisors can use the dashboard to monitor agent performance, generate reports, and maintain audit logs.

### BRIEF DESCRIPTION OF DRAWINGS

The foregoing summary, as well as the following detailed description of embodiments, is better understood when read in conjunction with the appended drawings. For the purpose of illustrating the disclosure, there is shown in the present document example constructions of the disclosure. The detailed description is described with reference to the following accompanying figures.

FIG. 1(a): illustrates a network implementation of a system for integrating landing pages into campaign tool, in accordance with an embodiment of the present subject matter.

FIG. 1(b): illustrates the architecture of the system for integrating landing pages into campaign tool, in accordance with an embodiment of the present subject matter.

FIG. 1(c): illustrates a block diagram showing an integration of landing pages in a preferred embodiment of the present invention.

FIG. 2: illustrates a flow chart performing a method for integrating landing pages into campaign tool, in accordance with an embodiment of the present subject matter.

The figure depicts various embodiments of the present disclosure for purposes of illustration only. One skilled in the art will readily recognize from the following discussion that alternative embodiments of the structures and methods illustrated herein may be employed without departing from the principles of the disclosure described herein.

### DETAILED DESCRIPTION

Some embodiments of this disclosure, illustrating all its features, will now be discussed in detail. The words “comprising”, “having”, and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any devices and methods similar or equivalent to those described herein can be used in the practice or testing of embodiments of the present disclosure, the exemplary, devices and methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

Following is a list of elements and reference numerals used to explain various embodiments of the present subject matter.

| Reference Numeral | Element Description |
|---|---|
| 100 | System |
| 102 | User device |
| 103 | Network |
| 104 | Channel |
| 105 | Memory |
| 106 | CPaaS platform |
| 107 | Processor |
| 108 | Landing pages |
| 110 | Campaign tool |
| 112 | Agent dashboard |
| 114 | Marketer |
| 116 | Bot developer |
| 200 | Method |

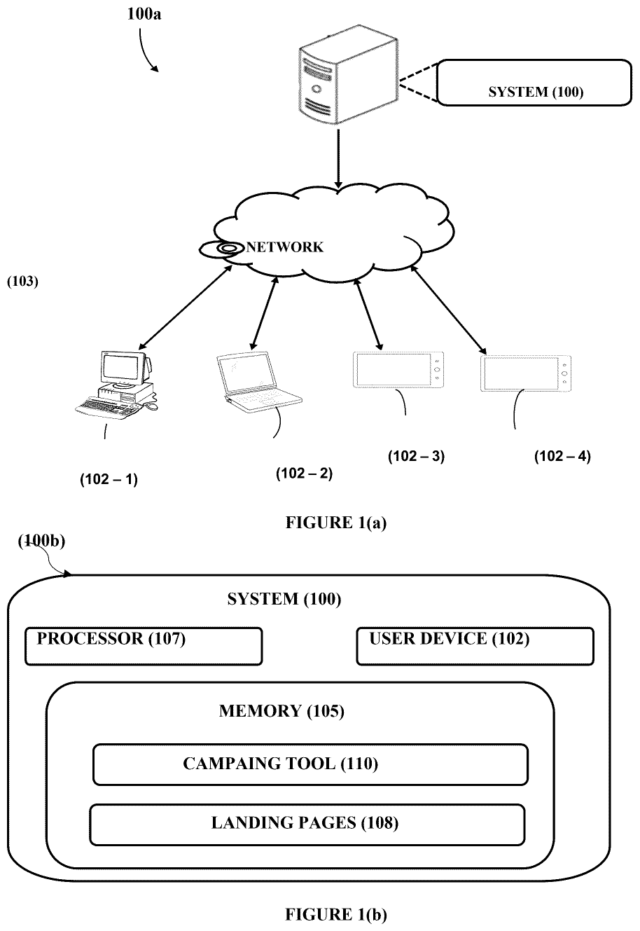

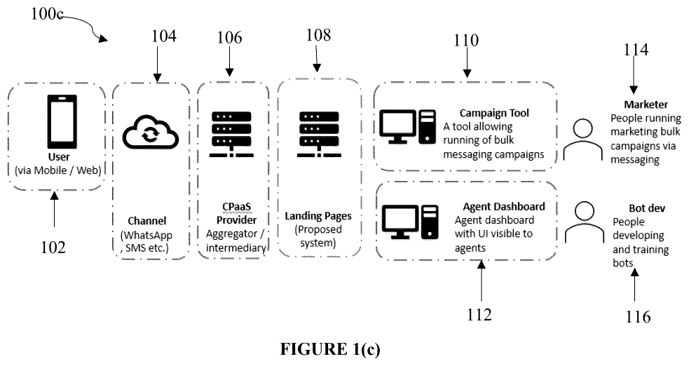

Referring now to FIG. 1(a), a network implementation (100a) of a system (100) is illustrated. The system (100) is being implemented on a server, it can be understood that it may also operate on various computing systems, such as laptops, desktops, notebooks, workstations, mainframes, or within cloud-based environments. Multiple users can access the system (100) through various user devices (102-1) (102-2) (102-3) (102-4), collectively referred to as users or stakeholders, which may include IoT devices, IoT gateways, portable computers, personal digital assistants, handheld devices, and workstations, all communicatively coupled to the system (100) through a network (103). This network (103) may be wireless, wired, or a combination of both, and can take the form of intranets, local area networks (LAN), wide area networks (WAN), or the internet, utilizing various protocols such as HTTP, HTTPS, and TCP/IP. Furthermore, the network (103) may comprise a range of devices, including routers, bridges, servers, and storage devices.

Referring now to FIG. 1(b), illustrates the architecture of a system (100) for integrating landing pages (108) into a campaign tool (110), in accordance with an embodiment of the present subject matter. As shown, the system (100) includes a user device (102) operably connected to a channel (104) (as shown in FIG. 1(c)) through which campaign-related messages are transmitted and received. The channel (104) may comprise any suitable medium such as SMS, email, or over-the-top (OTT) messaging applications. A Communications Platform as a Service (CPaaS) platform (106) (as shown in FIG. 1(c)) is operably coupled to the channel (104). The CPaaS platform (106) manages the delivery of outbound campaign messages to users and reception of inbound replies from the user device (102). The CPaaS platform (106) further enforces governance policies such as opt-in verification, message rate limits, and ensures reliable and secure message routing across multiple channels.

The system further comprises a memory (105) and a processor (107), where the memory (105) stores campaign information such as campaign metadata, target user lists, message templates, and predefined chat landing page journeys, while the processor (107) is configured to execute instructions stored in the memory (105) to control system operation. The campaign tool (110), implemented by the processor (107), enables a marketer (114) (as shown in FIG. 1(c)) to define and manage campaigns, including registering metadata, uploading or segmenting target users, and linking outbound campaigns or advertisements with a plurality of chat landing pages (108). The campaign metadata may include user identifiers, advertisement identifiers, referral codes, and other attributes necessary to uniquely identify and track campaigns.

In an embodiment, the plurality of chat landing pages (108) are operably coupled to both the CPaaS platform (106) and the campaign tool (110), and are configured to automate repetitive campaign tasks such as sending outbound messages, tracking message delivery, and verifying campaign messages against stored metadata. The landing pages (108) further execute predefined chat journeys in response to inbound user replies, wherein the chat journey progresses dynamically based on user inputs until either completion or the occurrence of a handoff condition. In some embodiments, the landing pages (108) comprise a WYSIWYG editor that allows creation, validation, and storage of chat workflow graphs as JSON objects, thereby enabling flexible design and execution of campaign-linked journeys.

The system (100) further integrates a bot (116) (as shown in FIG. 1(c)), which is configured to process inbound user messages that fall outside the scope of a registered campaign or arise upon completion of a landing page journey. The bot (116) is operable to process such queries using natural language understanding, generate context-aware responses, access relevant service or content data, and continue conversations initiated via the landing page journey. A simulated user message or structured context package, representing the state of the completed journey, may be forwarded from the landing pages (108) to the bot (116) for seamless interaction continuity. The bot (116) also supports dynamic handoff to live agents when escalation conditions are detected.

The system also comprises an agent dashboard (112) (as shown in FIG. 1(c)) that provides real-time monitoring and support capabilities for agents. The agent dashboard (112) enables queue assignment, access to canned replies, knowledge search, and conversation histories. In addition, the agent dashboard (112) provides supervisory functions such as monitoring agent performance, tracking campaign effectiveness, and generating compliance reports. By integrating landing pages (108), the bot (116), and the agent dashboard (112) into a unified architecture, the system (100) enables a seamless flow of campaign-related in interactions across automated journeys, bot-assisted processing, and human-assisted escalation.

In an embodiment, the system (100) provide a campaign-linked ephemeral chat landing pages (108). The chat landing pages (108) are server-executed, short-lived, stateful micro-journeys that are bound to specific outbound advertisement campaigns. Upon completion of a given micro-journey, the system (100) is configured to atomically transfer the conversation to a downstream bot (116) or agent via the agent dashboard (112). In an embodiment, the transfer includes a structured context capsule that preserves user inputs, campaign metadata, and intermediate journey states.

Referring to FIG. 1(c), a system (100c) for integrating landing pages (108) into the campaign tool (110) is illustrated. In accordance with an embodiment of the present invention, the system (100) comprises user device (102), channel (104), a Communications Platform as a Service (CPaaS) platform (106), landing pages (108), a campaign tool (110), agent dashboard (112), marketer (114), and bot developer (116). In one embodiment, the landing pages (108) are integrated between the CPaaS platform (106) and the bot. In another embodiment, the chat landing pages (108) may be integrated with the campaign tool (110) and the agent dashboard (112). Additionally, the chat landing pages (108) integrate with outbound/ad campaign tools (110) on one side and with bot development tools on the other.

In one embodiment, the user device (102) may be a mobile device, web device, computer, laptop, or similar. The user device (102) is associated with a user. For instance, each user from a plurality of users may use a user device (102).

Further, the channel (104) may be a platform used for communication between the user and an agent. The channel (104) may include platforms such as WhatsApp, email, messaging services, SMS, or similar. For example, the channel (104) may correspond to an application downloaded on the user device (102) by the user.

The CPaaS provider (106) may be a cloud-based platform that provides businesses with Application Programming Interfaces (APIs) for integrating real-time communication features like SMS, voice calls, video chat, and similar functionalities into their applications. The CPaaS platform (106) may also offer various services, such as control governance, disaggregation, and strict compliance with privacy regulations relevant to industries like healthcare, education, or finance.

In another embodiment, the CPaaS platform (106) operates as a high-performance, multi-tenant messaging infrastructure. The CPaaS platform (106) supports execution of outbound campaigns involving hundreds of millions of messages while maintaining two-way messaging latency under 10 milliseconds. The CPass platform may comprises a multi-tenant architecture that ensures disaggregation of capacity, wherein only a small fraction (approximately 0.1-1%) of marketers (114) execute live campaigns at a given time, thereby optimizing infrastructure utilization. The CPaaS platform (106) further enforces governance controls, including opt-in verification prior to campaign messaging, throttling mechanisms to prevent excessive messages to individual users, enforcement of per-channel compliance constraints, and secure handling of Personally Identifiable Information (PII).

The campaign tool (110) allows for the execution of bulk message campaigns. It can send messages to multiple users simultaneously. For example, the campaign tool (110) may run a campaign by sending messages to a large number of users. The campaign tool (110) is managed by a marketer (114), who may be part of a group responsible for executing bulk messaging campaigns.

Furthermore, the agent dashboard (112) connects a plurality of agents to a plurality of users. The agent dashboard (112) includes a user device (102) accessible to each agent. Each agent from the group may access the agent dashboard (112) using an agent device (not shown), which could be a mobile device, computer, laptop, or similar. In one embodiment, each agent provides assistance to users, addressing queries, and offering services or responses.

The agent dashboard (112) may provide a specialized interfaces for operational stakeholders. The agent dashboard (112) serves as a real-time agent desk, comprising a web chat interface, live queue assignment, skills-based or round-robin routing, canned responses, knowledge search, private notes, and a campaign management console. The agent dashboard (112) is implemented as a single-page application (SPA), with Redis/MySQL serving as stateful storage, and WebSockets enabling live updates and event-driven synchronization across multiple agent terminals. The marketer (114) provides a campaign management environment, comprising a Landing Pages Studio for journey creation, audience upload and segmentation modules, campaign registry, A/B testing controls, calendar-based scheduling, cost and conversion analytics, and experiment reporting modules. The console is implemented as a SPA with Redis/MySQL backing storage, background job processing for bulk uploads, feature flagging for controlled rollouts, and persistent audit logs for every publish action.

The marketer (114) is responsible for creating advertisements or campaigns for events such as festivals, galas, and functions. Additionally, the bot developer (116) is a developer who creates chatbots for various purposes. Users can interact with the chat bot, which is designed to perform specific tasks. A bot is an automated software application that performs repetitive tasks over a network (103).

In one embodiment, the system (100) is configured with technical mechanisms for bot (116) integration. Upon completion of a predefined chat landing page journey, the system (100) generates a simulated user message enriched with contextual information, including prior user responses, campaign metadata, and journey state. In an embodiment, the chat landing pages journey may be referred to as a landing page journey. This simulated message is transmitted to the bot (116) or an external NLP system. The bot (116) is unaware of the existence of the landing page module (108), and interprets the simulated message as a new inbound message from a user. This feature ensures compatibility with existing NLP frameworks, allowing the bot (116) to execute natural language understanding, intent detection, and context-aware response generation without requiring any modification to its native processing pipeline. In an embodiment, the handoff is achieved atomically through a context capsule, ensuring continuity of user experience and eliminating cold-start conditions.

In one aspect, the bot developer (116) is responsible for constructing and maintaining downstream conversational bots (116). The bot developer (116) configures domain-specific capabilities, such as catalog browsing, payment transactions, support workflows, FAQs, and other enterprise functions. The bot developer (116) additionally manages natural language understanding (NLU) models, retrieval-augmented generation (RAG) indexes, and intent libraries, while ensuring PCI and PII compliance across downstream actions. The bot developer (116) also implements handoff semantics, which enable the bot (116) to transfer control to human agents under escalation conditions, and subsequently reclaim control to resume automated handling when appropriate.

Specifically, FIG. 1 demonstrates the integration of landing pages (108) into the campaign tool (110). The marketer (114) creates a landing page journey and provides campaign details such as user IDs and a campaign message template. This journey, often generated from pre-existing templates, guides users when they engage with the campaign. The marketer (114) uploads a file containing a list of target users into the campaign tool (110), which then sends marketing messages sequentially to each user. The landing pages (108) tracks the campaign messages being sent, verifies their link to the campaign details, and forwards the campaign message to the CPaaS platform (106). The CPaaS platform (106) then sends the message to the user through the channel (104). When the user replies, the channel (104) forwards the response to the CPaaS platform (106), which then sends it to the landing pages (108). If the incoming messages are related to a pre-existing campaign, the landing pages (108) uses the predefined journey to respond. If the incoming messages are unrelated to an existing campaign, or if the user's journey is complete, the landing pages (108) forwards the message to the bot, which then replies to the user.

Further below table illustrates the method steps or sequence of action performed by the lading pages system with the outbound campaign:

| Steps | From | To | Details |
|---|---|---|---|
| 1 | Marketer | Landing | The marketer (114) creates a landing page journey |
| | (114) | pages (108) | and provides campaign details (user ids, campaign |
| | | | message template). This is a short journey, often |
| | | | created from pre-existing templates that guide a user |
| | | | when they come in via a campaign. |
| 2 | Marketer | Campaign | The marketer (114) uploads a file in the campaign |
| | (114) | tool (110) | tool (110) containing a list of target users. |
| 4 | Campaign | Landing | The campaign tool (110) sends the marketing |
| | tool (110) | pages (108) | messages one by one to each of the users in the file. |
| 5 | Landing | CPaaS | The Landing pages (108) notes the campaign |
| | pages | Platform | messages being sent and verifies that they link to the |
| | (108) | (106) | campaign details provided in step 1. |
| 6 | CPaaS | Channel | The CPaaS Platform (106) provides various services |
| | Platform | (104) | like control governance, disaggregation etc., and |
| | (106) | | forwards the message to the channel (104) |
| 7 | Channel | User | The channel (104) sends the message to the user. |
| | (104) | | |
| 8 | User | Channel | The user replies to the message. |
| | | (104) | |
| 9 | Channel | CPaaS | The channel (104) forwards the user replies to the |
| | (104) | Platform | CPaaS Platform (106). |
| | | (106) | |
| 10 | CPaaS | Landing | The CPaaS Platform (106) forwards the user replies |
| | Platform | pages | to the landing pages (108). |
| | (106) | (108) | |
| 11a | Landing | CPaaS | If the incoming messages are related to a pre-existing |
| | pages | Platform | campaign, the landing pages (108) uses the journey |
| | (108) | (106) | configured in step 1 to respond to the user message. |
| 11b | Landing | Bot | If the incoming messages are not related to a pre- |
| | pages | | existing campaign or if the journey for the user is |
| | (108) | | complete, the landing pages (108) forwards the |
| | | | message to the bot. |
| 12b | Bot | CPaaS | The bot replies to the user message. |
| | | Platform | |
| | | (106) | |
| | | | (steps same as steps 6 and 7 ensure that reply reaches |
| | | | the end user and the steps continue) |

In accordance with an embodiment of the present invention described the working of the lading pages system with the Ad campaign tool (110). The marketer (114) creates a landing page journey and provides campaign details (user ids, Ad id, referral codes, etc.). This is a short journey, often created from pre-existing templates that guide a user when they come in via a campaign. The marketer (114) create an advertisement in existing tools and links the ad to the messaging application. As soon as user clicks on the Ad and the user is redirected to the messaging application. The user sends a pre-composed attached to the ad via the channel (104). The channel (104) forwards the pre-composed message to the CPaaS Platform (106) and further to the landing pages (108). If the incoming messages are related to a pre-existing campaign (either the pre-composed message or a user reply to a landing pages journey, the landing pages (108) uses the journey configured in step 1 to respond to the user message. If the incoming messages are not related to a pre-existing campaign or if the journey for the user is complete, the landing pages (108) forwards the message to the bot. If the incoming messages are not related to a pre-existing campaign or if the journey for the user is complete, the landing pages (108) forwards the message to the bot. The bot replies to the user message. The CPaaS Platform (106) forwards the message to the channel (104). The channel (104) sends the message to the user. The user replies to the message. The channel (104) forwards the user replies to the CPaaS Platform (106).

In one embodiment, the system (100) determines whether an incoming message is related to a pre-existing campaign by evaluating reference identifiers or advertisement identifiers associated with the message. When a user clicks on an outbound advertisement, the corresponding channel (104) appends a reference identifier or advertisement identifier to the inbound message. In certain cases, the message itself is pre-populated with the campaign identifier before transmission. The system (100) utilizes these identifiers to match the incoming message against the registered campaign metadata in the campaign tool (110). If a match is found, the message is routed to the corresponding chat landing page (108). Otherwise, the message is directed to the bot (116) for handling.

In another embodiment, the chat landing pages (108) are implemented as workflow graphs, wherein each node represents a unit of processing logic and each edge represents a conditional transition to the next node. Specific nodes are configured as pause-and-wait nodes, where execution halts until a reply is received from the user device (102). Typically, such nodes initiate a message to the user and resume execution upon receipt of the corresponding reply. The workflow graph is encoded as a JSON object and stored in a persistent database. A WYSIWYG editor integrated with the journey builder module of the campaign tool (110) allows marketers (114) to visually construct and validate these workflows. At runtime, the JSON representation of the workflow graph is retrieved upon receipt of a user message within the chat landing page context, and the system (100) executes the appropriate processing node to determine the subsequent interaction.

In an embodiment, the campaign-linked chat workflows that act as ephemeral entry points for user interactions. Unlike conventional campaign tools that merely support bulk messaging or static forms, the system (100) introduces a chat workflow builder as a chat landing page, tightly integrated with campaign metadata and seamlessly linked to downstream bots (116) or agents (112). This configuration allows campaign-specific micro-journeys to be created, executed, and completed without requiring modifications to the main conversational bot, thereby reducing launch time and eliminating cold-start conditions.

The system (100) maintains a mapping of inbound messages to campaign context by relying on channel-specific identifiers with respect to user identity and campaign association. The system (100) may utilize a user's phone number or other unique identifiers available through the CPaaS platform (106) to associate responses with a specific campaign. This mechanism ensures that campaign-linked workflows are executed reliably without ambiguity in message routing.

Further below table illustrates the method steps or sequence of action performed by the lading pages system with the Ad campaign:

| Steps | From | To | Details |
|---|---|---|---|
| 1 | Marketer | Landing | The marketer (114) creates a landing page journey and |
| | (114) | pages | provides campaign details (user ids, Ad id, referral |
| | | (108) | codes, etc.). This is a short journey, often created from |
| | | | pre-existing templates that guide a user when they |
| | | | come in via a campaign. |
| 2 | Marketer | Ad tool | The marketer (114) create an Ad in existing tools (like |
| | (114) | | Meta AD manager) and links the ad to the messaging |
| | | | application. |
| 3 | User | Ad | The user clicks on the Ad and is redirected to the |
| | | | messaging application. |
| 4 | User | Channel | The user sends a pre-composed attached to the ad via |
| | | (104) | the channel (104). |
| 5 | Channel | CPaaS | The channel (104) forwards the pre-composed message |
| | (104) | Platform | to the CPaaS Platform (106). |
| | | (106) | |
| 6 | CPaaS | Landing | The CPaaS Platform (106) forwards the pre-composed |
| | Platform | pages | message to the Landing pages (108). |
| | (106) | (108) | |
| 7a | Landing | CPaaS | If the incoming messages are related to a pre-existing |
| | pages | Platform | campaign (either the pre-composed message or a user |
| | (108) | (106) | reply to a landing pages (108) journey), the landing |
| | | | pages (108) uses the journey configured in step 1 to |
| | | | respond to the user message. |
| 7b | Landing | Bot | If the incoming messages are not related to a pre- |
| | pages | | existing campaign or if the journey for the user is |
| | (108) | | complete, the landing pages (108) forwards the |
| | | | message to the bot. |
| 8b | Bot | CPaaS | The bot replies to the user message. |
| | | Platform | |
| | | (106) | |
| 9 | CPaaS | Channel | The CPaaS Platform (106) provides various services |
| | Platform | (104) | like control governance, disaggregation etc. and |
| | (106) | | forwards the message to the channel (104) |
| 10 | Channel | User | The channel (104) sends the message to the user. |
| | (104) | | |
| 11 | User | Channel | The user replies to the message. |
| | | (104) | |
| 12 | Channel | CPaaS | The channel (104) forwards the user replies to the |
| | (104) | Platform | CPaaS Platform (106). |
| | | (106) | |
| | | | (steps same as steps 6 and 7 ensure that reply is handled |
| | | | properly and the steps continue) |

In an embodiment, the system (100) is designed to streamline the management of both outbound and ad campaigns by automating key processes. For outbound campaigns, marketers (114) begin by creating a landing page journey that includes campaign details and uploading a list of target users. The campaign tool (110) then sends out messages, which are managed and tracked by the Landing pages (108). User responses are routed through the CPaaS platform (106) and are either handled by the Landing pages (108) if relevant to the campaign or forwarded to a bot for further interaction. In the case of ad campaigns, marketers set up an advertisement linked to a messaging application. When a user clicks on the ad, they are redirected to the messaging app, where a pre-composed message is automatically sent. The system (100) processes these messages in a manner similar to outbound campaigns, determining whether the response can be handled by the pre-set journeys or if it requires bot interaction. The sequence of actions in both outbound and ad campaigns involves multiple steps, with messages passing between various components, including marketers, campaign tools (110), the CPaaS platform (106), channels, users, and bots. This ensures that the campaign and user interactions are managed seamlessly. By automating these processes, the system (100) significantly reduces the time and effort needed to manage campaigns, enabling marketing teams to operate more efficiently, particularly in fast-paced scenarios.

In another embodiment, the Chat landing pages (108) operates as the central hub, integrating various tools and platforms to ensure seamless communication and efficient campaign management. In an embodiment, the campaign toll may be referred to as a campaign management tool. It begins with the utilization of ad management tools to design and schedule campaigns, define target audiences, and craft messages. These tools then push essential campaign data, including user lists and messaging content, to the Chat Landing pages (108). Integration between these tools and the Chat Landing pages (108) is achieved through APIs, which allow the campaign management tools to send campaign details and trigger the sending of messages via the Communication Platform as a Service (CPaaS) platform. CPaaS platforms (106) are responsible for the actual delivery of messages to users across various channels (104) like SMS, WhatsApp, and Facebook Messenger. When a user responds, the CPaaS platform captures the message and routes it back to the Chat Landing pages (108). This real-time communication is facilitated through API integration, ensuring that messages are sent according to the campaign schedule and that user responses are immediately received and processed by the system (100). In instances where a user interaction requires more complex handling, bots comes into play. The Chat landing pages (108) forwards messages requiring bot intervention to these platforms. The bots, integrated with the system (100) through API calls, process user queries—often using natural language processing (NLP) capabilities—and send back appropriate responses. These responses are then routed back to the user via the CPaaS platform (106), maintaining a smooth and continuous interaction. Overall, the Chat Landing pages (108) serves as the orchestrator, coordinating between campaign management tools, CPaaS platforms (106), bots, and other components. It effectively manages the flow of data, routes messages, and ensures that user responses are either handled through pre-configured journeys or escalated to bots when necessary, providing a cohesive and efficient communication experience across all touchpoints.

In an embodiment, the campaign management tool (110) implemented as a marketer (114)-centric console to define, launch, govern, and monitor advertisement campaigns linked with chat landing pages (108) (108). The campaign management tool (110) provides an integrated environment that enables campaign design, execution, and oversight while ensuring compliance with communication channel (104) policies and user privacy preferences.

The campaign management tool (110) comprises an audience and campaign registry configured to upload or segment target user lists and register outbound campaign metadata. The campaign metadata may include campaign identifiers, user identifiers, advertisement identifiers, referral codes, message templates, and additional campaign-specific attributes. This registry provides a structured repository that ensures all campaign-related details are consistently linked to one or more chat landing pages (108).

The campaign management tool (110) further comprises a journey builder, implemented as a visual workflow editor that enables marketers (114) to create and modify deterministic micro-journeys in the form of chat landing pages (108). The journey builder supports drag-and-drop creation of workflow nodes, validation of node configurations, and storage of the workflows as machine-readable objects such as JSON files. The journey builder also supports seamless handoff of user interactions to an existing bot (116) or to human agents through the agent dashboard (112), ensuring uninterrupted communication flow.

In another embodiment, the campaign management tool (110) comprises a template library configured to provide pre-approved content for use in outbound campaigns across multiple channels (104), including WhatsApp, SMS, email, and other messaging platforms. The template library maintains hierarchical sets of content bundles, including locale-specific variants, multimedia assets, and channel-specific compliance hints to ensure regulatory adherence across jurisdictions.

The campaign management tool (110) further supports standard advertisement management features to optimize campaign effectiveness. These features include A/B testing to evaluate multiple campaign variants, analytics dashboards for real-time monitoring of campaign performance, role-based access control (RBAC) for managing marketer (114) and supervisor permissions, and approval workflows to ensure campaign governance. Additionally, the campaign management tool (110) implements end-user opt-in/opt-out management mechanisms to comply with user privacy requirements and provides tools for secure handling of personally identifiable information (PII).

In an embodiment, the system's architecture (100c) relies on API-based integrations to ensure that data flows smoothly between different tools. The Chat landing pages (108) acts as the central hub, coordinating interactions between the various components. Middleware plays a crucial role in connecting systems with different data formats and protocols. Security tools ensure that all data exchanges are protected, while analytics tools provide feedback on performance. The entire system (100) is continuously developed, tested, and deployed using development and testing tools, ensuring that updates are seamless and do not disrupt existing workflows. This interconnected network of tools allows for a highly efficient, automated, and scalable approach to managing messaging-based marketing campaigns.

As per one example, a campaign entitled “72-Hour Flash Diwali Gold Sale” executed over communication channel (104) illustrates the end-to-end operation of the chat landing pages (108). In the setup phase, the marketer (114) uploads an audience file containing user phone numbers and related details, and registers campaign identifier CAM-0913-FLASH with the communication channel (104) template FLASH_PROMO_01, which includes an image and a “know more” call-to-action button, together with an associated time window. The marketer (114) then authors a landing page journey identified as “flash-sale-opting v3”. The landing pages (108) comprising sequential nodes configured to greet the user, provide contextual information about the Diwali festival and gold-buying traditions, and persuade the user to consider purchasing gold online, with a subsequent handoff node to a bot for transactional engagement. Once validated and approved, the landing page is published and governance checks clear the communication channel (104) template for outbound messaging. During the outreach phase, outbound messages are delivered to the targeted audience via the CPaaS platform (106) and communication channel (104). When a user interacts with the “know more” button, the communication channel's pre-composed text carries embedded identifiers (e.g., ad_id=AD123 and ref_code=R9), which the CPaaS platform (106) forwards to the landing page ingress.

Further, the landing pages (108) may detects that the inbound interaction corresponds to a recent campaign with an incomplete landing page journey and marks the message as in-scope. The landing page system (100) then executes the configured journey, delivering welcome and persuasive messages, and subsequently hands off the conversation to the bot, which is initialized with the gold ornaments category. The bot allows the user to browse catalog items, add products to the cart, and proceed to checkout by generating a payment link. Upon successful confirmation, the bot concludes the transaction and the handoff. The landing page may marks the journey as completed, logs telemetry data, and attributes the conversion to the campaign CAM-0913-FLASH, thereby enabling downstream analytics and attribution reporting.

The technical advancement achieved by the chat landing pages (108) lies in their intermediate orchestration role between a CPaaS platform (106) and conversational bots or agents. For in-scope messages associated with an active campaign, the system (100) executes the marketer (114)-configured journey to provide contextual and deterministic interactions, while out-of-scope messages are seamlessly forwarded to the bot (116). This configuration provides several technical effects, including reduced time-to-launch, as marketers (114) are able to design and deploy campaign-specific micro-journeys within hours, independently of bot development cycles, improved conversion rates, as context-sensitive chat landing pages (108) enable higher completion of user actions, and enhanced reliability, as the structured context capsule eliminates the cold-start problem typically encountered by downstream bots and agents.

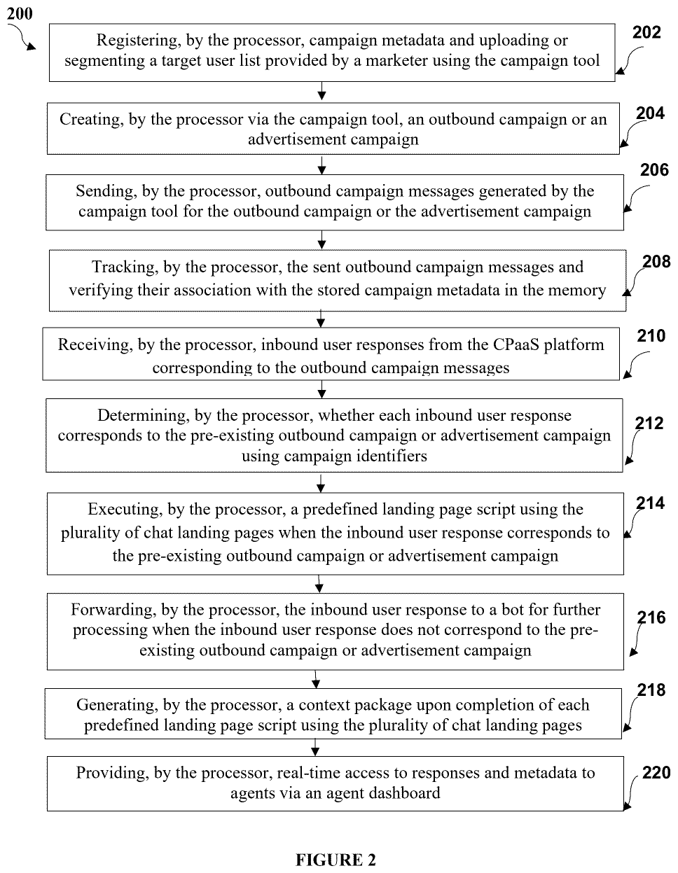

In an embodiment, the FIG. 2 illustrates a flow chart performing a method (200) for integrating landing pages (108) into campaign tool (110) using a system (100) comprising a processor (107) coupled with a memory (105), in accordance with an embodiment of the present subject matter. The order in which the method (200) may be described may be not intended to be construed as a limitation, and any number of the described method blocks may be combined in any order to implement the method (200) or alternate methods. Additionally, individual blocks may be deleted from the method (200) without departing from the spirit and scope of the subject matter described herein. Furthermore, the method (200) may be implemented in any suitable hardware, software, firmware, or combination thereof. However, for ease of explanation, in the embodiments described below, the method (200) may be considered to be implemented as described in the system (100) for integrating landing pages (108) into campaign tool (110).

In an embodiment, the method (200) for integrating landing pages (108) into a campaign tool (110) using a system (100) comprising a memory (105) and a processor (107) operably coupled to the memory (105), wherein the memory (105) is configured to store campaign information including campaign metadata, target user lists, message templates, and predefined chat landing page scripts.

At step (202), registering, by the processor (107), campaign metadata and uploading or segmenting a target user list provided by a marketer (114) using the campaign tool (110), wherein the campaign metadata includes user identifiers, advertisement identifiers, referral codes, and attributes for uniquely identifying and tracking campaigns.

At step (204), creating, by the processor (107) via the campaign tool (110), an outbound campaign or an advertisement campaign as defined by the marketer (114), and linking the outbound campaign or the advertisement campaign to a plurality of chat landing pages (108), wherein the outbound campaign comprises a bulk messaging campaign to the target user list and the advertisement campaign comprises an advertisement linked to a messaging application.

At step (206), sending, by the processor (107), outbound campaign messages generated by the campaign tool (110) for the outbound campaign or the advertisement campaign sequentially from the plurality of chat landing pages (108) through a Communications Platform as a Service (CPaaS) platform (106) via a selected communication channel (104) to target users associated with a user device (102).

At step (208), tracking, by the processor (107), the sent outbound campaign messages and verifying their association with the stored campaign metadata in the memory (105) using the plurality of chat landing pages (108).

At step (210), receiving, by the processor (107), inbound user responses from the CPaaS platform (106) corresponding to the outbound campaign messages.

At step (212), determining, by the processor (107), whether each inbound user response corresponds to the pre-existing outbound campaign or advertisement campaign using campaign identifiers, including advertisement IDs, referral codes, or reference codes, via the plurality of chat landing pages (108).

At step (214), executing, by the processor (107), a predefined landing page script using the plurality of chat landing pages (108) when the inbound user response corresponds to the pre-existing outbound campaign or advertisement campaign, wherein the predefined landing page script comprises a sequence of automated interactions that progresses dynamically based on user inputs, such as text replies or selections, until completion of the sequence or occurrence of a handoff condition requiring advanced processing.

At step (216), forwarding, by the processor (107), the inbound user response to a bot (116) for further processing when the inbound user response does not correspond to the pre-existing outbound campaign or advertisement campaign or upon completion of the predefined landing page script, wherein the bot (116) generates context-aware responses using natural language understanding and supports dynamic handoff to live agents.

At step (218), generating, by the processor (107), a context package upon completion of each predefined landing page script using the plurality of chat landing pages (108), wherein the context package represents a state of the completed landing page script and simulates a user message for continued processing by the bot (116).

At step (220), providing, by the processor (107), real-time access to responses and metadata to agents via an agent dashboard (112), wherein the responses include conversation histories and pre-written replies, and the metadata includes data associated with the conversation histories and agent routing assignments, and enabling supervisors to monitor agent performance metrics, generate campaign efficiency reports, and maintain audit logs using the agent dashboard (112).

A preferred method (200) of implementing the invention comprises registering a campaign in the campaign registry with selected channels, time windows, templates, and budget parameters, authoring the landing page journey in the Landing Pages Studio. Further, the method (200) may validate the workflow graph, approving and publishing it, transmitting outbound campaign messages via the CPaaS platform (106) or linking outbound ads to click-to-chat journeys associated with the campaign. The method (200) is receiving inbound messages and executing a matching service to determine whether the messages are in-scope of a registered campaign, executing the landing page journey using the runtime orchestrator until completion or handoff when the message is determined to be in-scope, attaching a structured context capsule to a simulated user message and forwarding the same to the bot (116) for continued processing upon occurrence of a handoff, and persisting all events while updating agent dashboard (112) and refreshing analytics modules in real time.

In one embodiment, the above method (200) is implemented by the system (100) through a combination of the campaign tool (110), chat landing pages (108), CPaaS platform (106), bot (116), agent dashboard (112), and marketer (114), thereby ensuring end-to-end orchestration of campaign-linked micro-journeys with reliable handoff, governance, and analytics integration.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

1. A system (100) for integrating landing pages (108) into campaign tool (110), the system (100) comprising:
a memory (105) configured to store campaign information, comprising campaign metadata, target user lists, message templates, and a predefined chat landing page journeys; and
a processor (107) operably coupled to the memory (105), wherein the processor (107) is configured to perform the following steps:
register (202) the campaign metadata and upload or segment a target user list provided by a marketer (114) using the campaign tool (110);
create (204), via the campaign tool (110), an outbound campaign or an advertisement campaign as defined by the marketer (114);
link the outbound campaign or the advertisement campaign to a plurality of chat landing pages (108);
send (206) outbound campaign messages generated by the campaign tool (110) for the outbound campaign or the advertisement campaign sequentially from the plurality of chat landing pages (108) through a Communications Platform as a Service (CPaaS) platform (106) via a selected communication channel (104) to target users associated with a user device (102);
track (208) the sent outbound campaign messages and verify their association with the stored campaign metadata in the memory (105) using the plurality of chat landing pages (108);
receive (210) inbound user responses from the CPaaS platform (106) corresponding to the outbound campaign messages;
determine (212) whether each inbound user response corresponds to a pre-existing outbound campaign or advertisement campaign using campaign identifiers, including advertisement IDs, referral codes, or reference codes, via the plurality of chat landing pages (108);
execute (214) a predefined landing page journey using the plurality of chat landing pages (108) when the inbound user response corresponds to the pre-existing outbound campaign or advertisement campaign, wherein the landing page journey progresses dynamically based on user inputs until completion or occurrence of a handoff condition;
forward (216) the inbound user response to a bot (116) when the inbound user response does not correspond to the pre-existing outbound campaign or advertisement campaign or upon completion of the predefined landing page journey,
generate (218) a context package upon completion of each predefined landing page journey using the plurality of chat landing pages (108), wherein the context package represents a state of the completed landing page journey and simulates a user message for continued processing by the bot (116); and
provide (220) real-time access to responses and metadata to agents via an agent dashboard (112), and enable supervisors to monitor agent performance metrics, generate campaign efficiency reports, and maintain audit logs using the agent dashboard (112).

2. The system (100) as claimed in claim 1, wherein the campaign metadata comprises user identifiers, advertisement identifiers, referral codes, and attributes for uniquely identifying and tracking campaigns.

3. The system (100) as claimed in claim 1, wherein the outbound campaign comprises a bulk messaging campaign to the target user list and the advertisement campaign comprises an advertisement linked to a messaging application.

4. The system (100) as claimed in claim 1, wherein the predefined landing page journey executed by the plurality of chat landing pages (108), wherein the predefined landing page journey comprises a script defined as a predefined sequence of automated interactions.

5. The system (100) as claimed in claim 4, wherein the script is implemented as a workflow graph stored in the memory (105) as a JSON object, each node of the workflow graph representing a processing step comprises sending a message or prompting a user input via the user device (102), and each edge representing a conditional transition based on the user inputs, such as text replies or selections,
wherein the script progresses dynamically until completion or a handoff condition occurs when the user input requires processing beyond the script's predefined interactions, such as a complex query or transaction request.

6. The system (100) as claimed in claim 1, wherein the bot (116) generates context-aware responses using natural language understanding and supports dynamic handoff to live agents.

7. The system (100) as claimed in claim 1, wherein the responses accessible via the agent dashboard (112), wherein the agent dashboard comprise user conversation histories, user inputs, system responses from the plurality of chat landing pages (108) and the bot (116), and pre-written replies stored in the memory (105) for agent use, and
wherein the metadata comprises conversation identifiers, campaign identifiers, and routing data for assigning user interactions to agents, and wherein the agent dashboard (112) further provides access to a searchable knowledge database stored in the memory (105) to enable agents to retrieve information for responding to user queries.

8. The system (100) as claimed in claim 1, wherein the CPaaS platform (106) is configured to manage the transmission of campaign-related messages between the user device (102) and the chat landing pages (108), wherein the CPaaS platform (106) provide multi-channel message delivery across at least one of SMS, email, or messaging applications, enforce governance policies including opt-in verification and message rate limits, and ensure secure, reliable, and scalable handling of inbound and outbound messages for multiple campaigns.

9. The system (100) as claimed in claim 1, wherein the campaign tool (110) is configured to enable the marketer (114) to define, manage, and customize campaigns, including uploading or segmenting target user data, and registering campaign metadata, wherein the campaign metadata comprises user identifiers, campaign advertisement identifiers, referral codes, or other campaign-specific attributes, and associating outbound or advertisement campaigns with plurality of chat landing pages (108) for automated interaction with the targeted users.

10. The system (100) as claimed in claim 1, wherein the plurality of chat landing pages (108) are configured to automate repetitive campaign tasks over a network (103),
wherein the plurality of chat landing pages (108) are configured to send outbound campaign messages sequentially to a list of target users uploaded by the marketer (114), and track delivery status for each message.

11. The system (100) as claimed in claim 1, wherein the processor (107) is operably coupled to the plurality of chat landing pages (108), the bot (116), and the agent dashboard (112) through API-based integrations.

12. The system (100) as claimed in claim 1, wherein the plurality of chat landing pages (108) is configured to:
track outgoing campaign messages sent through the campaign tool (110) and associate each message with campaign metadata including user IDs, campaign IDs, and journey templates;
receive incoming user responses through the communication channels (104) and CPaaS platform (106) along with message metadata and user identification;
analyze the incoming user responses using pattern matching and campaign correlation algorithms to determine relevance to existing campaigns;
route campaign-related responses to predefined journey responses stored in campaign templates with automated progression through conversation flows; and
route non-campaign related responses and completed journey messages to the automated bot for natural language understanding, intent classification, and intelligent response generation.

13. A method (200) for integrating landing pages (108) into a campaign tool (110) using a system (100) comprising a memory (105) and a processor (107) operably coupled to the memory (105), wherein the memory (105) is configured to store campaign information including campaign metadata, target user lists, message templates, and predefined chat landing page scripts, the method (200) comprising:
registering (202), by the processor (107), campaign metadata and uploading or segmenting a target user list provided by a marketer (114) using the campaign tool (110), wherein the campaign metadata includes user identifiers, advertisement identifiers, referral codes, and attributes for uniquely identifying and tracking campaigns;
creating (204), by the processor (107) via the campaign tool (110), an outbound campaign or an advertisement campaign as defined by the marketer (114), and linking the outbound campaign or the advertisement campaign to a plurality of chat landing pages (108), wherein the outbound campaign comprises a bulk messaging campaign to the target user list and the advertisement campaign comprises an advertisement linked to a messaging application;
sending (206), by the processor (107), outbound campaign messages generated by the campaign tool (110) for the outbound campaign or the advertisement campaign sequentially from the plurality of chat landing pages (108) through a Communications Platform as a Service (CPaaS) platform (106) via a selected communication channel (104) to target users associated with a user device (102);
tracking (208), by the processor (107), the sent outbound campaign messages and verifying their association with the stored campaign metadata in the memory (105) using the plurality of chat landing pages (108);
receiving (210), by the processor (107), inbound user responses from the CPaaS platform (106) corresponding to the outbound campaign messages;
determining (212), by the processor (107), whether each inbound user response corresponds to the pre-existing outbound campaign or advertisement campaign using campaign identifiers, including advertisement IDs, referral codes, or reference codes, via the plurality of chat landing pages (108);
executing (214), by the processor (107), a predefined landing page script using the plurality of chat landing pages (108) when the inbound user response corresponds to the pre-existing outbound campaign or advertisement campaign, wherein the predefined landing page script comprises a sequence of automated interactions that progresses dynamically based on user inputs, such as text replies or selections, until completion of the sequence or occurrence of a handoff condition requiring advanced processing;
forwarding (216), by the processor (107), the inbound user response to a bot (116) for further processing when the inbound user response does not correspond to the pre-existing outbound campaign or advertisement campaign or upon completion of the predefined landing page script, wherein the bot (116) generates context-aware responses using natural language understanding and supports dynamic handoff to live agents;
generating (218), by the processor (107), a context package upon completion of each predefined landing page script using the plurality of chat landing pages (108), wherein the context package represents a state of the completed landing page script and simulates a user message for continued processing by the bot (116); and
providing (220), by the processor (107), real-time access to responses and metadata to agents via an agent dashboard (112), wherein the responses include conversation histories and pre-written replies, and the metadata includes data associated with the conversation histories and agent routing assignments, and enabling supervisors to monitor agent performance metrics, generate campaign efficiency reports, and maintain audit logs using the agent dashboard (112).
